(19) United States
(12) Patent Application Publication
(10) Pub. No.: US 2006/0085575 A1
(43) Pub. Date: Apr. 20, 2006

(54) Storage network system, host computer and physical path allocation method

(75) Inventors: Masaaki Hosouchi, Zama (JP); Kenichi Oyamada, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/008,404

(22) Filed: Dec. 8, 2004

(30) Foreign Application Priority Data
Oct. 19, 2004 (JP) 2004-304562

(51) Int. Cl. G06F 3/06

(52) U.S. Cl. 710/38

(57) ABSTRACT

The object of the invention is to prevent differential data transfer for a volume pair from being stopped by the influence of another volume pair and make the loads on physical paths equal to each other by finding an optimum allocation of the physical paths to logical paths. A storage network system includes a host computer 10 and a plurality of storage subsystems 20, and the host computer 10 or a storage subsystem 20 checks a pair status of a volume pair consisting of a source logical volume 26p and a target logical volume 26s, determines a coefficient value uniquely determined from the pair status as a load value of the volume pair, determines a sum of load values of volume pairs belonging to the group to which the source volume belongs as a group load value, and allocates a number of physical paths corresponding to the group load value and a plural-group load value, which is a sum of the load values of a plurality of groups, to the volume pairs belonging to the group as a logical path, which is a virtual communication link.

The present application claims priority based on Japanese patent application No. 2004-304562 filed on Oct. 19, 2004, the entire contents of which are hereby incorporated by reference.

### BACKGROUND

The disclosure of the present application relates to a remote copy function for copying a volume in a storage subsystem into another storage subsystem. In particular, it relates to a method of dynamically allocating a physical path used as a data transfer channel for a remote copy.

Remote copying is a technique for reducing the risk of losing data in a storage subsystem due to a disaster or a failure. The remote copying is a technique that produces copies of logical volumes of two storage subsystems without the intervention of a host computer and, if one logical volume is updated, transfers differential data, which is data concerning differences between the two logical volumes, to the other logical volume, thereby keeping the two logical volumes retaining the same data. The logical volume is a logical disk device for a host computer. In a storage subsystem, the logical volume is constituted by a part or the whole of the storage area of one or more disk devices. By locating two storage subsystems at physically distant places, if a disaster strikes one of the storage subsystems, operations can be resumed early using the copy of the data retained in the other storage subsystem. A remote copying technique is described in Japanese Patent Application Laid-Open Publication No. 2004-145855 (hereinafter referred to as Patent Document 1), for example.

The remote copying technique is generally classified into the synchronous type and the asynchronous type. In the synchronous type remote copying, when data is input to or output from a primary volume, the input or output data is transferred to a secondary volume, and a response to the host computer is made after the completion of the data transfer to the secondary volume is ensured. Therefore, although no data is lost, the response time increases. In the asynchronous type remote copying, a response to the host computer is made before input to or output from the primary volume is completed, and the data transfer to the secondary volume is not synchronized with the input to or output from the host computer. Therefore, although the response time does not increase, there is the risk of losing data. An appropriate one of the two types is adopted depending on the distance between the storage subsystems or the influence of the data loss.

The differential data is transferred from one logical volume to another via a dedicated line or public line connected to input/output interfaces of the storage subsystems, the input/output interface being referred to as a port. One storage subsystem has a plurality of ports therein and can transfer differential data concerning one or more logical volumes via plural links. However, since the link capacity is limited, if data becomes concentrated on a particular link as the number of logical volumes to be remote-copied increases, a bottleneck occurs and the transfer of the differential data is stopped. Thus, a technique for distributing the load of the remote copying among ports for remote copying is described in the Patent Document 1. According to this technique, the load of the remote copying process is distributed by providing a common memory that stores information about the load status in the storage subsystem and reallocating, to another port, some of the volumes to be remote-copied allocated to a port for remote copying for which the load status exceeds a threshold.

When one storage subsystem has a plurality of logical volumes that are to be remote-copied, the amount of transferred data and requirements about remote copying for the logical volumes are not always the same. For example, if a logical volume for backup is remote-copied in an asynchronous manner while another logical volume to be used for an online operation is copied and only differential data is transferred in a synchronous manner, there arises a need to transfer the whole of the logical volume for backup while transferring the differential data of the logical volume for the online operation. Since the transfer data amount significantly differs between the transfer of only the differential data and the transfer of the whole of the logical volume, and most of the link capacity is used for backup, the transfer of the differential data of the logical volume for the online operation may be delayed, leading to a delay in response of the online operation or a stop of the transfer of the differential data due to a timeout.

If the communication link is fixedly divided to avoid the interaction between the remote copying for the online operation and the remote copying for the backup operation, the link used for the backup operation cannot be used even if the backup operation is not performed.

In the Patent Document 1, there is described an attempt to achieve load distribution by reducing the number of logical volumes to be remote-copied when the load exceeds a threshold. However, if one or more logical volumes are randomly selected, the effect of the approach varies because the effect of moving a volume to another port varies depending on whether only the differential data of the volume is transferred, the whole of the volume is transferred or the transfer of the volume is suspended, or depending on the update frequency of the volume. In addition, according to the technique described in the Patent Document 1, the purposes for which the logical volumes are used (for an online operation, for backup, for example) are not taken into account, and thus, it is impossible to avoid an influence of a vast amount of data transfer caused by a plurality of volumes using one link for different purposes on remote copying of another volume.

### SUMMARY

To solve at least one of the problems described above, one aspect of the present invention provides a storage network system comprising: a host computer; and a plurality of storage subsystems connected to the host computer via a network, the storage network system being capable of copying data stored in a logical volume in a storage subsystem into a logical volume in another storage subsystem, wherein said host computer checks a pair status of a volume pair, which is a pair of a source logical volume and a target logical volume that is established between a source storage subsystem and a target storage subsystem, determines a coefficient value uniquely determined from said pair status as a load value of the volume pair, determines, for each group consisting one or more volume pairs, a sum of the load values of the volume pairs in the group as a group load value, and transmits to said storage subsystems via the network an instruction to allocate a number of physical paths corresponding to said group load value and a plural-group load value, which is a sum of the load values of a plurality of groups, to the volume pairs belonging to said group as a logical path, which is a virtual communication link, and said storage subsystems perform allocation of a logical path in accordance with said instruction. The word “all” in this specification means the whole that is influenced in physical path allocation.

With the storage network system, the host computer and the physical path allocation method according to the present invention, it is possible to avoid a stop of transfer of differential data due to a timeout.

### BRIEF DESCRIPTION OF THE DRAWINGS

FIG. 1 shows a hardware configuration according to an example 1;

FIG. 2 shows an exemplary configuration of a volume pair management table;

FIG. 3 shows an exemplary configuration of a group management table;

FIG. 4 shows an exemplary configuration of a physical path management table;

FIG. 5 shows an exemplary configuration of a logical path management table;

FIG. 6 is a flowchart showing a physical path reallocation process;

FIG. 7 shows an exemplary configuration of a transfer-direction-based load information table;

FIG. 8 shows an exemplary configuration of group parameters;

FIG. 9 shows an example of a group parameter file;

FIG. 10 shows an exemplary configuration of a pair information table;

FIG. 11 shows an exemplary configuration of a group information table;

FIG. 12 shows an exemplary configuration of a path information table;

FIG. 13 shows an exemplary configuration of a physical path information table;

FIG. 14 is a flowchart illustrating an information collection processing in the physical path reallocation process;

FIG. 15 is a flowchart illustrating a load analysis processing in the physical path reallocation process;

FIG. 16 is a flowchart illustrating an allowable value comparison processing in the physical path reallocation process;

FIG. 17 is a flowchart illustrating a physical path reconfiguration processing in the physical path reallocation process; and

FIG. 18 shows a hardware configuration according to a modification of the example 1.

### DETAILED DESCRIPTION OF THE PREFERRED EMBODIMENTS

The best mode for carrying out the present invention will be described.

In the following, a storage network system, a host computer and a physical path allocation method according to examples of the present invention will be described in detail with reference to the drawings.

### EXAMPLE 1

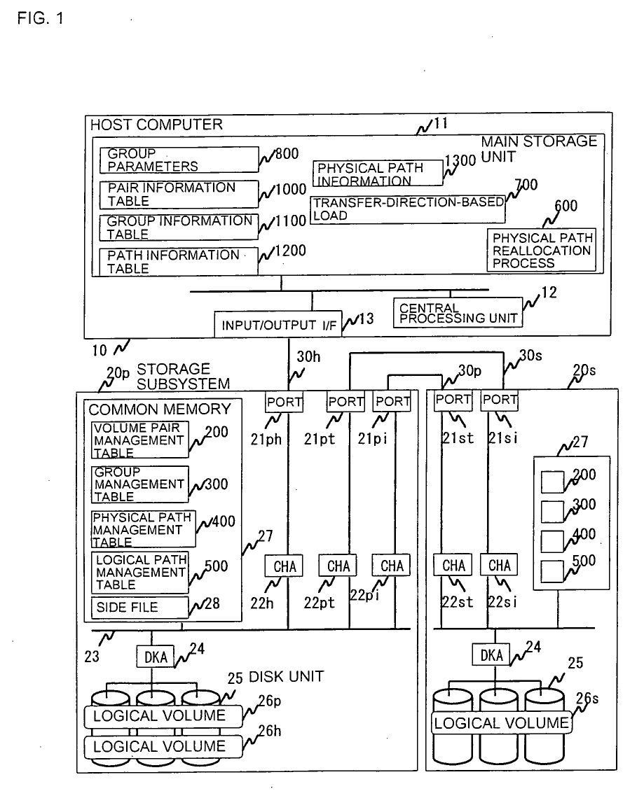

An example 1 will be described. FIG. 1 shows an example of a hardware configuration of a system to which the present invention is applied. In FIG. 1, reference numeral 10 denotes a host computer according to the present invention, which comprises a main storage unit 11, a central processing unit 12 and an input/output interface 13, such as a host channel adapter. A storage network system according to this example checks the pair status of all the volume pairs, each of which is a pair of a source logical volume and a target logical volume, involved in the remote copying conducted between a source storage subsystem and a target storage subsystem, determines a coefficient value uniquely determined by the pair status as a load value P of each volume pair, determines a total load value A by summing the load values P of all the volume pairs involved in the remote copying conducted between the source storage subsystem and the target storage subsystem, and allocates a number of physical paths, corresponding to the load value P of each volume pair, to each volume pair as a logical path, which is a virtual communication link for the volume pair.

Reference numeral 20 denotes a storage subsystem having a remote copy capability, which is connected to the interface 13 of the host computer 10 via a network 30h constituted by an optical fibre cable, a switch and the like.

The storage subsystem 20 comprises a port 21, which is an interface, such as a fibre channel or SCSI, a channel adapter CHA 22 that controls the port 21, one or more disk units 25, which are hardware having a physical storage area, a disk adapter DKA 24 that controls input/output of the one or more disk units 25, a bus or switch 23, which is a data communication link between the port 21 and the disk units 25, and a common memory 27, which is a storage unit accessible by the CHA 22 and DKA 24. Here, one storage subsystem 20 may comprise these components 21 to 27 in plural numbers.

The host computer 10 logically divides the physical storage area of the disk unit 25 and manages and uses the physical storage area on a logical-division basis. Each logical division of the storage area of the disk unit 25 is referred to as a logical volume 26. The physical location of the volume 26 in the disk unit 25 is retained in the memory 27.

In the remote copying, a volume 26p in a storage subsystem 20p connected to the host computer 10 is copied, and a volume 26s is created in the disk unit 25 of another storage subsystem 20s. If the target storage subsystem 20s is connected to the source storage subsystem 20p, the target storage subsystem 20s may not be directly connected to the host computer 10. The source logical volume 26p which is to be copied is referred to as a primary volume, the target logical volume 26s is referred to as a secondary volume, and a pair of a primary volume and a secondary volume is referred to as a volume pair. To maintain consistency or allow simultaneous manipulation or management, one or more volume pairs can be grouped. Thus, a group of volume pairs comprises at least one volume pair.

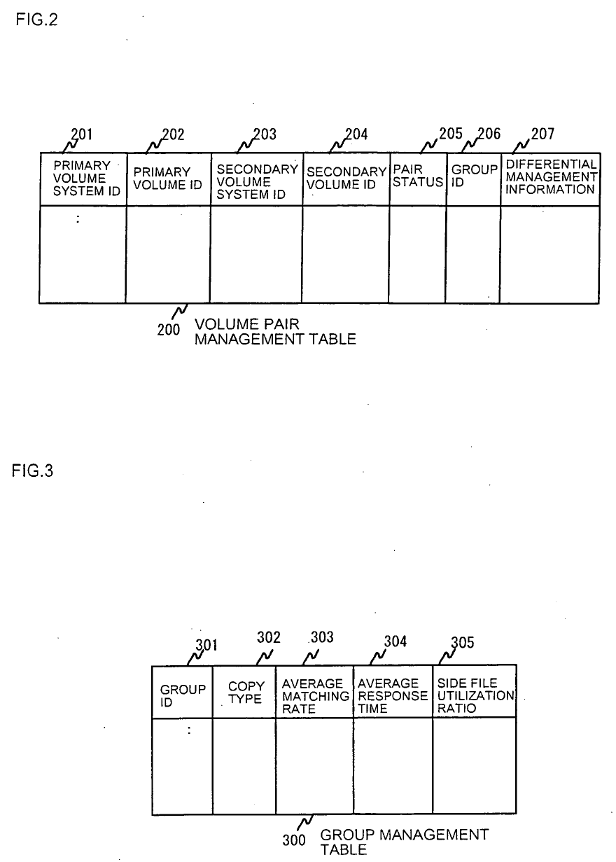

The volume pair is managed in accordance with a volume pair management table 200 in the memory 27. FIG. 2 shows an exemplary configuration of the table 200. The table 200 contains items for each volume pair including a system identifier (ID) 201, such as a serial number, that uniquely identifies the storage subsystem 20p having the primary volume 26p, a volume ID 202 that uniquely identifies the primary volume 26p in the storage subsystem 20p, a system ID 203 that uniquely identifies the storage subsystem 20s having the secondary volume 26s, a volume ID 204 that uniquely identifies the secondary volume 26s in the storage subsystem 20s, a pair status 205 of the volume pair, an ID 206 that identifies the group containing the volume pair, and differential management information 207, such as a bitmap of a region of different data between the primary volume and the secondary volume. The content of the region of the primary volume whose data differs from that of the secondary volume is referred to as differential data.

The pair status 205 indicates the matching status of the volume pair and the transfer status of the differential data and assumes any of the following:
a SIMPLEX status in which no pair is established, no data transfer occurs, and no differential management information 207 is retained;
a PENDING status in which a pair is established, data transfer from a primary volume to a secondary volume is started, but the data in the volumes have not yet matched with each other;
a DUPLEX status in which the copy transfer from the primary volume to the secondary volume has been completed, and only data concerning update of the primary volume is transferred as required; and
a SUSPEND status in which the data transfer to the secondary volume is suspended, and only the differential management information 207 is updated if the primary volume is updated.

Furthermore, according to the method of transferring the differential data of the volume pair, one of the following remote copy types (copy types) is selected:
a synchronous type in which, when data is input to or output from the primary volume, the input or output data is transferred to the secondary volume, and a response to the host computer is made after the completion of the data transfer to the secondary volume is ensured. In the DUPLEX status, the primary volume and the secondary volume always match with each other. The time required to complete the data transfer to the secondary volume which is started in response to an input or output request to the primary volume is referred to as a “response time”; and
an asynchronous type in which a response to the host computer is made before data input to or output from the primary volume is completed, and the data transfer to the secondary volume is not synchronized with the input to or output from the host computer. To make the update order of the primary volume and the update order of the secondary volume agree with each other, the update orders are managed by means of a side file 28, which is an internal table in the memory 27.

Now, a group management table 300 in the memory 27 will be described. FIG. 3 shows an exemplary configuration of the management table 300. The table 300 contains items for each group including an ID 301 that identifies the group, a copy type 302 common to all the volume pairs in the group, an average matching rate 303, which is an average of the rates of data matching between the primary volumes and secondary volumes of the volume pairs in the group (exact matching is assumed as a data matching rate of 100), an average response time 304, which is the average of the response times, and a utilization ratio 305 of the side file. However, the average response time 304 is available only when the copy type 302 is the synchronous type, and the side file utilization ratio 305 is available only when the copy type 302 is the asynchronous type. Here, the values of the items 302 to 305 may be stored in the table 200 on a volume-pair basis, rather than stored in the table 300.

A network 30p or 30s used by the volume pair for transfer of the differential data is referred to as a physical path. The physical path is identified by a combination of the identifier of a port 21pi in the storage subsystem 20p having the primary volume 26p, which is the starting point of the network 30p, and the identifier of a port 21st in the storage subsystem 20s having the secondary volume 26s, which is the endpoint of the network 30p. The port 21pi at the starting point is referred to as an initiator port. The port 21st at the endpoint is referred to as a target port.

The data is transferred in the direction from the initiator port to the target port. In the case where data is transferred from the storage subsystem 20s to the storage subsystem 20p, another physical path (the network 30s between an initiator port 21si in the storage subsystem 20s and a target port 21pt in the storage subsystem 20p) is used.

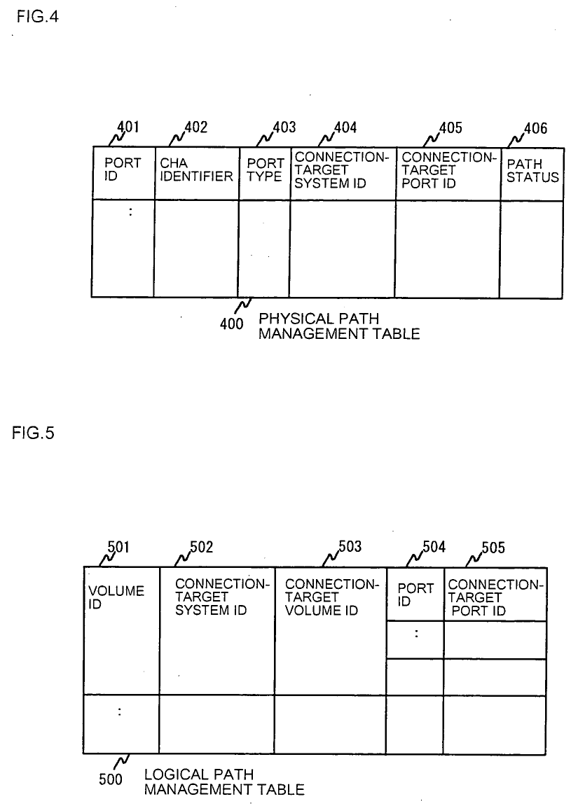

The physical path is managed by a physical path management table 400 in the memory 27. FIG. 4 shows an exemplary configuration of the table 400. The table 400 contains items including an ID 401 of the port 21 in the storage subsystem 20p, an identifier 402 of the CHA 22 that controls the port 21, a port type 403 that discriminates between the initiator port and the target port, an ID 404 of the storage subsystem 20s that is the connection-target of the port 21, an ID 405 of the port 21 in the storage subsystem 20s, and a path status 406 that indicates whether there is a connection target or not or whether a failure occurs in the physical path or not.

A virtual communication link between paired volumes is referred to as a logical path. The logical path is constituted by one or more physical paths. Information about which physical path is used by a volume pair is managed by a logical path management table 500. FIG. 5 shows an exemplary configuration of the table 500. There is provided one or more items for each of one or more volumes 26 in one storage subsystem 20. The items include a volume ID 501, which is an identifier of the volume 26 (in the case of one volume), or an identifier of any of plural volumes or a common part of the volume identifiers of the plural volumes (in the case of plural volumes). In addition, the items include an ID 502 of the connection-target storage subsystem 20s and one or more IDs 503 of one or more volumes in the connection-target storage subsystem. In addition, the items include an ID 504 of the initiator port 21 in the storage subsystem having the volume 26, and an ID 505 of the target port in the connection-target storage subsystem.

One volume pair may use a plurality of physical paths. Alternatively, a plurality of logical paths or volume pairs may share one physical path.

The main storage unit 11 of the host computer 10 retains a code of a physical path reallocation process 600 which implements the physical path allocation method according to the present invention, which is loaded and executed in the central processing unit 12. In addition, the main storage unit 11 stores various tables generated and referenced to in the physical path reallocation process 600, including group parameters 800 previously provided by a user, a pair information table 1000 generated from information of the volume pair management tables 200 obtained from the storage subsystems 20p and 20s, a group information table 1100 generated from information of the group management table 300, a path information table 1200 generated from information of the physical path management table 400 and the logical path management table 500, a physical path information table 1300 generated from the path information table 1200, and a transfer-direction-based load information table 700 generated from the group parameters 800, the pair information table 1000 and the group information table 1100.

The present invention is characterized in that, in the physical path reallocation process 600, a load weighted by the pair status is calculated based on the information of the tables 1000 to 1200 to reconfigure the allocation of physical paths to the logical paths, the physical path used by a volume pair in a group for which an allowable value in the group parameters 800 is exceeded is exclusively allocated to the group, and the order of priority of exclusive allocation is determined based on the copy type or pair status.

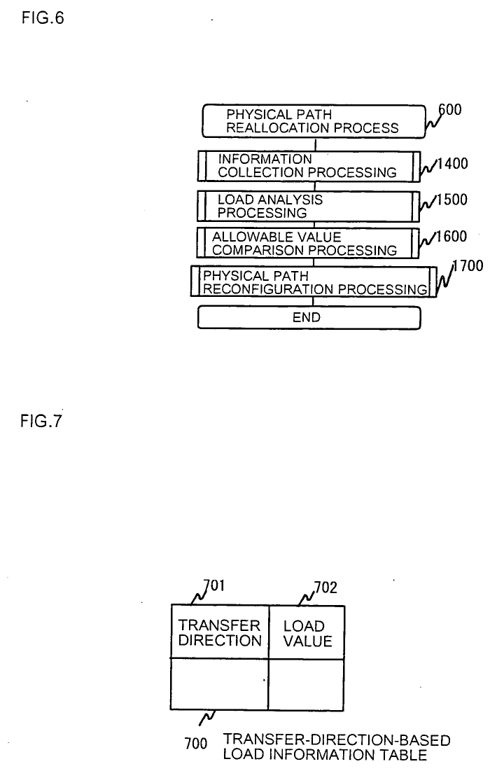

The physical real location process will be described. FIG. 6 is a flowchart illustrating the physical real location process. The physical path reallocation process 600 is performed at certain intervals, when a change of a pair status is detected via an inquiry to the storage subsystem 20s, and/or when a failure of a path is detected. In the physical reallocation process 600, an information collection processing 1400 for collecting information of the tables 200 to 500 from the storage subsystems 20p and 20s to know about the volume pairs and the configurations of the physical paths and logical paths, a load analysis processing 1500 for calculating a load from the collected information on a group basis or on a transfer-direction basis, an allowable value comparison processing 1600 for comparing an allowable value in the parameters 800 with the collected information to determine the group or volume pair to which a physical path is exclusively allocated, and a physical path reconfiguration processing 1700 for dynamically modifying the allocation of physical paths to logical paths based on the calculated load, the pair status, and the distinction about whether a physical path is occupied or shared are conducted in this order.

Now, an exemplary table generated in the information collection processing 1400 will be described. FIG. 7 shows an exemplary configuration of the transfer-direction-based load information table 700. Here, the transfer direction means the direction of transfer of the volume copy data and may be a direction from the storage subsystem 20s to the storage subsystem 20p and a direction from the storage subsystem 20p to the storage subsystem 20s. The transfer-direction-based load information table 700 contains information 701 that indicates which of the transfer directions relates to the relevant case and a load value 702 that represents a load concerning the transfer direction that is used in a substitution step of the load analysis processing 1500.

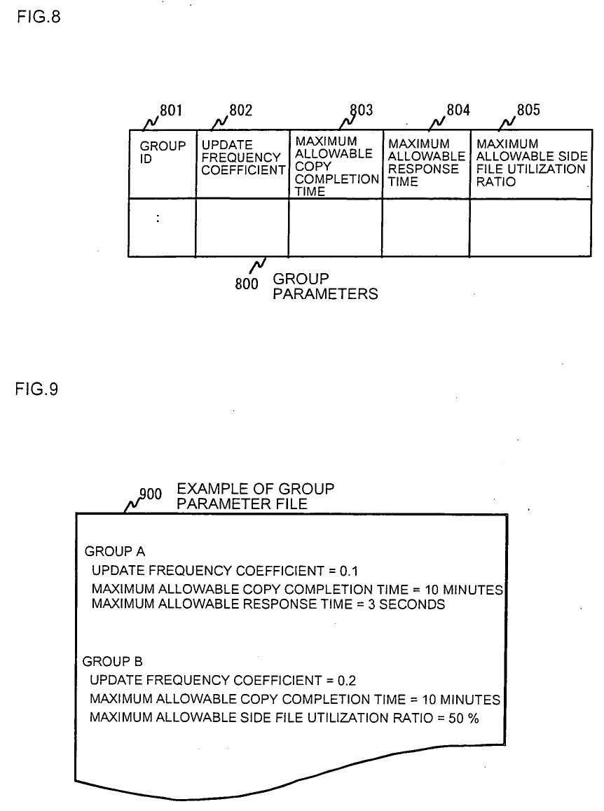

Now, the group parameters will be described. FIG. 8 shows an exemplary configuration of the group parameters 800. The group parameters 800 include items for each group. The items include a group ID 801, an update frequency coefficient 802 that indicates the amount of data transferred between the storage subsystem 20p and the storage subsystem 20s per unit time when the pair status is the DUPLEX status that is determined on the assumption that the transfer data amount per unit time at the time when the pair status is the PENDING status is “1”, a maximum allowable copy completion time 803 that indicates a maximum allowable value of the time from the time when the pair status changes from the SIMPLEX status to the PENDING status after a pair is established to the time when the pair status changes to the DUPLEX status, a maximum allowable response time 804 that indicates a maximum allowable average response time, and a maximum allowable side file utilization ratio 805 that indicates a maximum allowable side file utilization ratio. However, all the items 802 to 805 are not necessarily filled with values, and information irrelevant to the copy type may be omitted. Furthermore, in the case where certain information is not included, the maximum allowable value may be hypothetically determined.

The values 801 to 805 in the group parameters 800 are specified by the user. However, the coefficient 802 can be measured in the storage subsystem 20 and therefore may be obtained from the storage subsystem 20, rather than specified by the user. For example, the group parameters 800 are stored in a group parameter file, which is a file in a logical volume 26h that is accessible from the host computer 10, and loaded into the main storage unit 11 to generate the group parameters 800 when or before the information collection processing 1400 is conducted. FIG. 9 shows an example of the group parameter file. In FIG. 9, a group A is an exemplary specification of a group of the synchronous copy type, and a group B is an exemplary specification of a group of the asynchronous copy type.

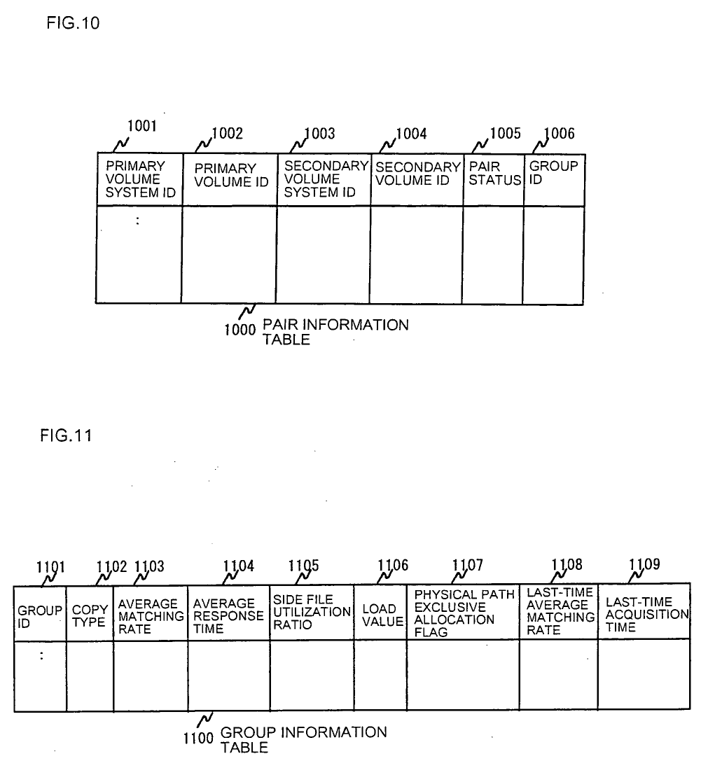

Now, the pair information table will be described. FIG. 10 shows an exemplary configuration of the pair information table. The pair information table 1000 is a subset of the volume pair management table 200 obtained by requesting the storage subsystem 20p or 20s and partly stored in the main storage unit 11. The pair information table 1000 retains only information required to reconfigure the path of the volume pair established between the storage subsystems 20p and 20s. Only an entry for which both the primary volume system ID 201 and the secondary volume system ID 203 equals to any of the identifiers of the storage subsystems 20p and 20s is extracted, and only the values of the items 201 to 206 of the entry are extracted. A primary volume system ID 1001 corresponds to the primary volume system ID 201, a primary volume ID 1002 corresponds to the primary volume ID 202, a secondary volume system ID 1003 corresponds to the secondary volume system ID 203, a secondary volume ID 1004 corresponds to the secondary volume ID 204, a pair status 1005 corresponds to the pair status 205, and a group ID 1006 corresponds to the group ID 206. Here, the pair information table 1000 contains no item corresponding to the differential management information 207 in the volume pair management table 200 shown in FIG. 2.

Now, the group information table will be described. FIG. 11 shows an exemplary configuration of a group information table 1100. The group information table 1100 is a subset of the group management table 300 obtained by requesting the storage subsystem 20 and stored in the main storage unit 11, additionally containing a region used in a substitution step of the physical path reallocation process 600. The group information table 1100 retains only information about the group including the volume pair established between the storage subsystems 20p and 20s. From the group management table 300, only an entry for which the group ID 301 equals to any of the group IDs 1006 in the group information table 1000 is extracted. A group ID 1101 corresponds to the group ID 301, a copy type 1102 corresponds to the copy type 302, an average matching rate 1103 corresponds to the average matching rate 303, an average response time 1104 corresponds to the average response time 304, and a side file utilization ratio 1105 corresponds to the side file utilization ratio 305. The region used in a substitution step of the physical path reallocation process 600 contains a load value 1106, which is a load of each group used in a substitution step of the load analysis processing 1400, a physical path exclusive allocation flag 1107 that indicates whether a physical path used by a volume pair in the group is exclusively occupied by the group or shared with another group, a last-time average matching rate 1108, which is a last time value of the average matching rate 1103, and a last-time acquisition time 1109 that indicates when the last physical path reallocation process 600 is conducted. If there is a volume pair that does not belong to any of the groups in the group information table 1100, the items maybe provided for the volume pair, and the volume pair information may be regarded as group information.

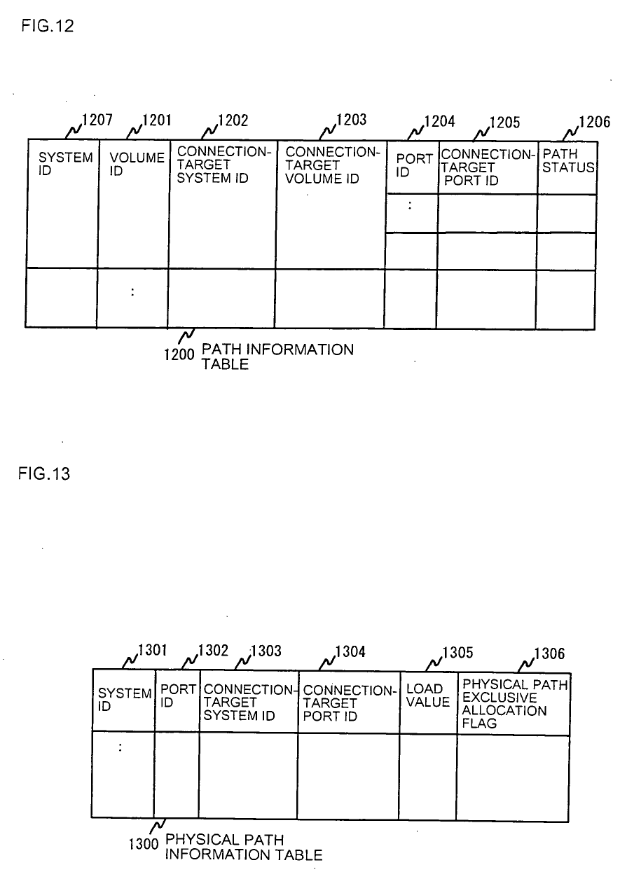

Now, the path information table will be described. FIG. 12 shows an exemplary configuration of the path information table. A path information table 1200 is a subset of the logical path management table 500 obtained by requesting the storage subsystem 20 and stored in the main storage unit 11, additionally containing a path status. The path information table 1200 retains only information about the logical path used by the volume pair established between the storage subsystems 20p and 20s and the physical path allocated to the logical path. From the logical path management table 500, only an entry is extracted for which the connection-target system ID 502 equals to any of the primary volume system IDs 1001 or any of the secondary volume system IDs 1003 in the pair information table 1000 and the volume ID 501 or the connection-target volume ID 503 equals to any of the primary volume IDs 1002 or any of the secondary volume IDs 1004. However, in the case where a logical path is used by a plurality of volumes, only an entry is extracted for which the volume ID 501 or the connection-target volume ID 503 equals to a part of the primary volume ID 1002 or the group ID of the group to which the volume belongs. A volume ID 1201 corresponds to the volume ID 501, a connection-target system ID 1202 corresponds to the connection-target system ID 502, a connection-target volume ID 1203 corresponds to the connection-target volume ID 503, a port ID 1204 corresponds to the port ID 504, and a connection-target port ID 1205 corresponds to the connection-target port ID 505. A system ID 1207 is substituted with the ID of the storage subsystem 20 from which the logical path management table 500 is obtained. Each entry has a path status 1206, and the path status 1206 is substituted with the path status 406 of the entry in the physical path management table 400 for which the port ID 401 equals to the port ID 504 and the connection-target port ID 405 equals to the connection-target port ID 505.

Now, the physical path information table will be described. FIG. 13 shows an exemplary configuration of a physical path information table 1300. The physical path information table 1300 is a table generated from the information of the path information table 1200. The physical path information table 1300 retains only information about a physical path which is recorded in the path information table 1200 and for which the path status 1206 is not “failed”. Entries of the physical path information table 1300 are those of the path information table 1200 excluding the entries for which the system ID 1207, the connection-target system ID 1202, the port ID 1204 and the connection-target port ID 1205 are the same. A load value 1305 is the value of the load on the physical path. A physical path exclusive allocation flag 1306 is a flag that indicates whether the physical path is exclusively occupied by one group or allocated to a plurality of groups.

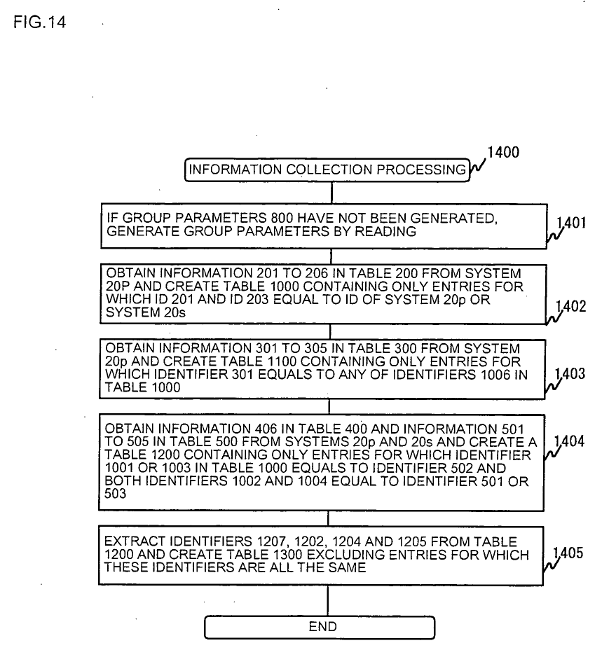

Now, the information collection processing 1400 will be described. FIG. 14 is a flowchart illustrating an example of the information collection processing. First, group parameters are generated by reading from a file stored in the logical volume 26h accessible from the host computer 10 or the like (step 1401). However, if parameters 800 have been already generated in the main storage unit 11, step 1401 can be omitted.

Then, information 201 to 206 in the volume pair management table 200 are obtained from the storage subsystem 20p, and a pair information table 1000 containing only entries for which both the primary volume system ID 201 and the secondary volume system ID 203 equal to the ID of the storage subsystem 20p or 20s is created (step 1402). Information 301 to 305 in the group management table 300 are obtained from the storage subsystem 20p, and a group information table 1100 containing only entries for which the group ID 301 equals to any of the group IDs 1006 in the pair information table 1000 is created (step 1403). The path status 406 in the physical path management table 400 and information 501 to 505 in the logical path management table 500 are obtained from the storage subsystems 20p and 20s, and a path information table 1200 containing only entries for which the primary volume system ID 1001 or secondary volume system ID 1003 of each entry in the pair information table 1000 equals to the connection-target system ID 502 and both the primary volume ID 1002 and the secondary volume ID 1004 equal to the volume ID 501 or the connection-target volume ID 503 is created (step 1404). From the path information table 1200, the system ID 1207, the connection-target system ID 1202, the port ID 1204 and the connection-target port ID 1205 are extracted, and a physical path information table 1300 excluding entries for which these identifiers are all the same is created (step 1405). Here, if the storage subsystem 20 retains the average matching rate 303 and the average response time 304 on a volume-pair basis rather than on a group basis, instep 1403, the average matching rates 303 and the average response times 304 for the volume pairs are added together for each group, the sums are divided by the number of volume pairs to determine the average values thereof, and the average values are substituted for the average matching rate 1103 and the average response time 1104.

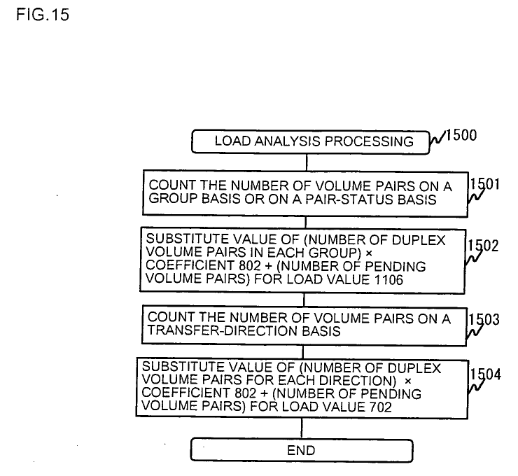

Now, the load analysis processing will be described. FIG. 15 is a flowchart illustrating an example of the load analysis processing 1500. First, referring to the pair information table 1000, the number of entries of the pair information table 1000, that is, the number of volume pairs is counted on a group or volume-pair basis and on a pair-status basis (step 1501), and a load value which is the counted number of volume pairs weighted by the pair status as shown below is substituted for the load value 1106 for each group (step 1502).
load value=(the number of volume pairs for which the pair status 1005 is the DUPLEX status)×coefficient+(the number of volume pairs for which the pair status 1005 is the PENDING status)

Here, if the average matching rate 303 is equal to or higher than a certain value, and the pair status is expected to change to the DUPLEX status before the next activation of the physical path reallocation process 600, the number of volume pairs for which the pair status 1005 is the PENDING status may be multiplied by a coefficient determined by the average matching rate 303 in order to accommodate a variation of the load due to a change of the pair status.

Then, referring to the pair information table 1000, the number of entries of the pair information table 1000, that is, the number of volume pairs is counted on a transfer-direction basis (step 1503). A different primary volume system ID 1001 or secondary volume system ID 1003 means a different transfer direction. The load value determined by the same calculation as with the load value 1106 is substituted for the load value 702 in the transfer-direction-based load information table 700 for each direction (step 1504).

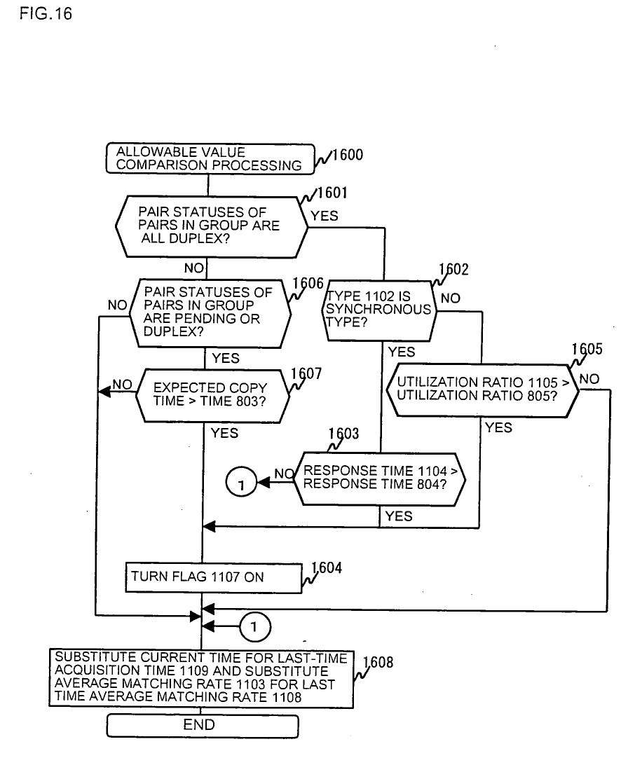

Now, the allowable value comparison processing 1600 will be described. FIG. 16 is a flowchart illustrating an example of the allowable value comparison processing. First, referring to the pair status 1005 in the pair information table 1000, it is determined whether the pair statuses 1005 of the volume pairs in the group are all the DUPLEX status, all the PENDING status or a mixture of the PENDING and DUPLEX statuses, or other statuses (step 1601). If the pair statuses are all the DUPLEX status, referring to the group information table 1100, it is determined whether the copy type 1102 is the synchronous type or asynchronous type (step 1602). If the copy type is the synchronous type, the maximum allowable response time 804 and the average response time 1104 are compared with each other. If the response time 1104 exceeds the maximum allowable response time 804 (step 1603), the physical path exclusive allocation flag 1107 is turned on (step 1604). If the copy type is the asynchronous type, the side file utilization ratio 1105 and the maximum allowable side file utilization ratio 805 are compared with each other. If the side file utilization ratio 1105 exceeds the maximum allowable side file utilization ratio 805 (step 1605), the physical path exclusive allocation flag 1107 is turned on (step 1604). In the case where the pair statuses are all the PENDING status or a mixture of the PENDING and DUPLEX statuses (step 1606), if the value of an expected copy time required for all the volume pairs to change into the DUPLEX status, which is determined by the following formula:
100/(last-time average matching rate 1108−average matching rate 1103(%))×(current time−last-time acquisition time 1109),
exceeds the maximum allowable copy completion time 803 (step 1607), the physical path exclusive allocation flag 1107 is turned on (step 1604). Finally, the current time is substituted for the last-time acquisition time 1109, and the average matching rate 1103 is substituted for the last-time average matching rate 1108 (step 1608).

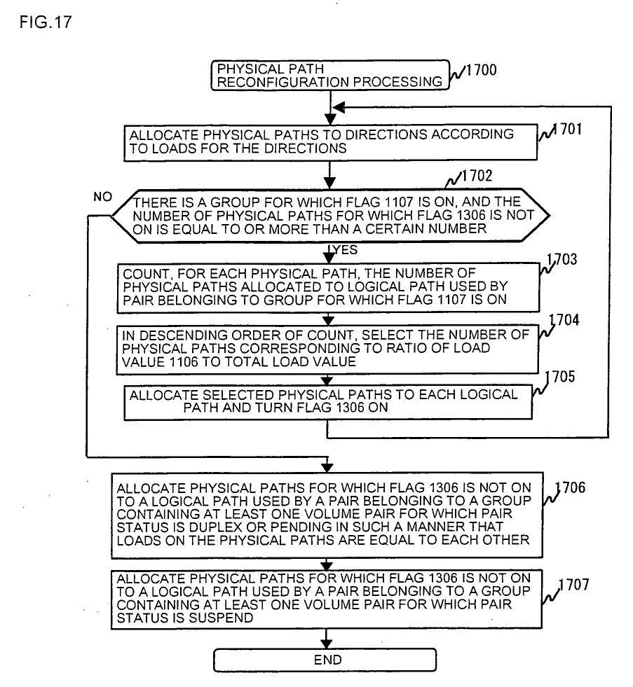

Now, the physical path reconfiguration processing 1700 will be described. FIG. 17 is a flowchart illustrating an example of the physical path reconfiguration processing. First, according to the loads for the transfer directions, the physical paths are allocated to the transfer directions (step 1701).

It is determined whether there is a group for which the physical path exclusive allocation flag 1107 is ON and the number of physical paths for which the physical path exclusive allocation flag 1306 is not ON is equal to or more than a certain number (step 1702). Here, the number of physical paths for each transfer direction is determined by the following formula: (the number of physical paths (the number of entries of the physical path information table 1300)×load value 702)/(sum of the load values 702). Then, the physical paths allocated for each transfer direction are separated into shared physical paths and exclusively occupied physical paths. To the group for which the physical path exclusive allocation flag 1107 is ON, a number of physical paths are exclusively allocated, the number of the exclusively allocated physical paths being determined by the following formula:

(the number of physical paths (the number of entries of the physical path information table 1300)×load value 1106)/(sum of the load values 1106). For the volume pairs in the group for which the physical path exclusive allocation flag 1107 is ON, the number of physical paths allocated to a logical path associated with an entry for which the system IDs and volume IDs 1001 to 1004 of the primary and secondary volumes equal to the system IDs and volume IDs 1207 and 1201 to 1203 is counted for each physical path (step 1703). In descending order of count, the number of physical paths determined by the calculation described above are allocated to the group (step 1704). In order for the allocated physical paths to be recognized as being exclusively occupied, the physical path exclusive allocation flag 1306 is turned on (step 1705). A command is issued to the storage subsystem 20p or 20s, thereby requesting the storage subsystem to release the currently allocated physical paths and reallocate the physical paths determined as described above to each logical path for the entry.

The processing of step 1703 is performed in the following order:

(1) the copy type is the synchronous type, and the pair statues of all the pairs are the DUPLEX status;

(2) the copy type is the asynchronous type, and the pair statues of all the pairs are the DUPLEX status; and

(3) the pair statuses are the PENDING status or the DUPLEX status.

To reduce the frequency of occurrence of a suspended status due to a stop of transfer, the synchronous type has higher priority than the asynchronous type, and copying in the DUPLEX status has higher priority than initial copying. If the number of shared physical paths, that is, the number of physical paths for the transfer direction minus the number of physical paths for which the physical path exclusive allocation flag 1306 is ON becomes less than a certain number during execution, it is determined that there is not enough resource to allow exclusive allocation, and further exclusive allocation is inhibited. The certain number equals to the number of physical paths that can be allocated to one logical path at the maximum, and the certain number may be specified in a parameter file 900 (step 1702).

Then, of the remaining groups (the group for which the physical path exclusive allocation flag 1107 is not ON), to a group that includes at least one volume pair whose pair status is the DUPLEX or PENDING status, the remaining physical paths (the physical paths for which the physical path exclusive allocation flag 1306 is not ON) are allocated in such a manner that the physical paths are shared by the volume pairs so that the paths are equally loaded. The pair status 1005 of the volume pairs in the group for which the physical path exclusive allocation flag 1107 is not ON is referred to to check whether there is a volume pair whose pair status is the DUPLEX or PENDING status. If any, from the entries for which the physical path exclusive allocation flag 1306 in the physical path information table 1300 is not ON, a number of entries corresponding to the maximum number of physical paths that can be allocated to one logical path are selected. If the number of entries for which the physical path exclusive allocation flag 1306 is not ON exceeds the maximum number of physical paths that can be allocated to one logical path, entries are selected in ascending order of load value 1305. The load values 1305 are all cleared to zero when the physical path reconfiguration processing 1700 is started, and a value of (load value 1106 for the group/the number of allocated physical paths) is added thereto after allocation. A command is issued to the storage subsystem 20p or 20s, thereby requesting the storage subsystem to release the currently allocated physical paths and reallocate the physical paths determined as described above to each logical path for the entry (step 1706).

Finally, of the remaining groups (the groups for which the physical path exclusive allocation flag 1107 is not ON and which include no volume pair whose pair status is the DUPLEX or PENDING status), for a group that includes at least one volume pair whose pair status is the SUSPEND status, from the entries for which the physical path exclusive allocation flag 1306 in the pair information table 1300 is not ON, a number of entries corresponding to the maximum number of physical paths that can be allocated to one logical path are selected. A command is issued to the storage subsystem 20p or 20s, thereby requesting the storage subsystem to release the currently allocated physical paths and reallocate the physical paths determined as described above to each logical path for the entry (step 1707).

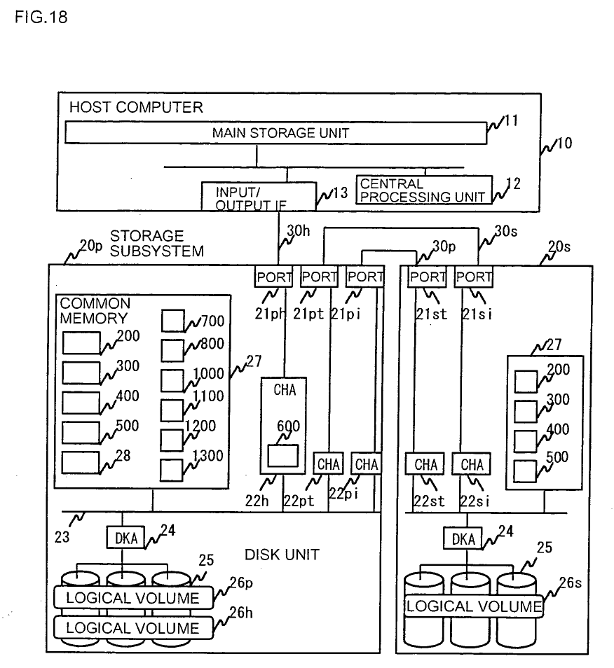

A modification of the example 1 will be described. In the example 1 described above, the physical path reallocation process 600 is performed in the host computer 10. However, the physical path reallocation process 600 may be performed in the storage subsystem 20p or 20s. According to this modification, the physical path reallocation process 600 is performed in the storage subsystem 20p or 20s, and FIG. 18 shows a hardware configuration thereof. The physical path reallocation process 600 is performed in the CHA 22 of any one of the storage subsystems 20p and 20s. The group parameters 800 are input to the storage subsystem 20 and stored in the common memory 27. The transfer-direction-based load information table 700, the pair information table 1000, the group information table 1100, the path information table 1200 and the physical path information table 1300 created in the physical path reallocation process 600 are also stored in the common memory 27. However, the pair information table 1000 and the group information table 1100 may be an expansion of the volume pair management table 200 and the group management table 300, respectively. The physical path reallocation process 600 according to this modification is the same as the physical path reallocation process 600 according to the example 1.

As described above with reference to the examples, according to an example of the present invention, the number of volume pairs belonging to a group is 1, and a storage network system comprises: a host computer; and a plurality of storage subsystems connected to the host computer via a network, the storage network system being capable of copying data stored in a logical volume in a storage subsystem into a logical volume in another storage subsystem, in which the host computer checks a pair status of a volume pair, which is a pair of a source logical volume and a target logical volume that is established between a source storage subsystem and a target storage subsystem, determines a coefficient value uniquely determined from the pair status as a load value of the volume pair, transmits to the storage subsystems via the network an instruction to allocate a number of physical paths corresponding to the load value of the volume pair and a plural-volume-pair load value, which is a sum of the load values of a plurality of volume pairs, to the volume pair as a logical path, which is a virtual communication link, and the storage subsystems perform allocation of a logical path in accordance with the instruction.

According to an example of the present invention, in the storage network system, the host computer is capable of copying a primary volume, which is a source logical volume, in a first storage subsystem into a secondary volume, which is a target logical volume, in a second storage subsystem or copying data stored in a primary volume in the second storage subsystem into a secondary volume in the first storage subsystem, checks a pair status of a volume pair, which is a pair of a source logical volume and a target logical volume that is established between the first storage subsystem and the second storage subsystem, and checks which volume of the paired volumes is the source logical volume, and the group load value used in allocation is a direction-based load value, which is a sum of the load values of volume pairs, whose source logical volumes reside in the first storage subsystem, of plural groups of volume pairs established between the first storage subsystem and the second storage subsystem. That is, the storage network system comprises a host computer and a plurality of storage subsystems connected to the host computer via a network, the storage network system being capable of copying data stored in a primary volume, which is a source logical volume, in a first storage subsystem into a secondary volume, which is a target logical volume, in a second storage subsystem or copying data stored in a primary volume in the second storage subsystem into a secondary volume in the first storage subsystem, in which the host computer checks a pair status of a volume pair, which is a pair of a source logical volume and a target logical volume that is established between the first storage subsystem and the second storage subsystem and which of the paired volumes is the source logical volume, determines a coefficient value uniquely determined from the pair status as a load value of the volume pair, determines a sum of the load values of a plurality of volume pairs, whose source logical volumes reside in the first storage subsystem, of plural groups of volume pairs established between the first storage subsystem and the second subsystem, as a direction-based load value, and transmits to the storage subsystems via the network an instruction to allocate a number of physical paths corresponding to the direction-based load value and a plural-group load value, which is a sum of the load values of the plural groups of pair volumes, to the volume pairs whose source logical volumes reside in the first storage subsystem as a logical path, which is a virtual communication link, and the storage subsystems perform allocation of a logical path in accordance with the instruction.

According to an example of the present invention, in the storage network system, the host computer allocates physical paths to volume pairs as a logical path, which is a virtual communication link, in ascending order of the load values of the physical paths. That is, the storage network system comprises: a host computer; and a plurality of storage subsystems connected to the host computer via a network, the storage network system being capable of copying data stored in a logical volume in a storage subsystem into a logical volume in another storage subsystem, in which the host computer checks a pair status of a volume pair, which is a pair of a source logical volume and a target logical volume that is established between a source storage subsystem and a target storage subsystem, determines a coefficient value uniquely determined from the pair status as a load value of the volume pair, and transmits to the storage subsystems via the network an instruction to allocate physical paths to volume pairs as a logical path, which is a virtual communication link, in ascending order of the load values of the physical paths, and the storage subsystems perform allocation of a logical path in accordance with the instruction.

According to an example of the present invention, the storage network system determines the load value on the assumption that the coefficient value at the time when the pair status is a PENDING status is 1, the coefficient value at the time when the pair status is a DUPLEX status is an update frequency coefficient, which is a ratio of the amount of data transferred when the pair status is the DUPLEX status to the amount of data transferred when the pair status is the PENDING status, and the coefficient value at the time when the pair status is neither the PENDING status nor the DUPLEX status is 0.

According to an example of the present invention, a storage network system comprises: a host computer; and a plurality of storage subsystems connected to the host computer via a network, the storage network system being capable of copying data stored in a logical volume in a storage subsystem into a logical volume in another storage subsystem, in which the host computer checks a copy type and a pair status of and copy mode change expectation information about a volume pair belonging to a group to which a source logical volume belongs, and transmits to the network subsystems via the network an instruction to exclusively allocate a physical path for the volume pair to a logical path, which is a virtual communication link, for the volume pair belonging to the group if the copy mode change expectation information exceeds an allowable value previously individually specified for the group, and the storage subsystems performs allocation of a logical path in accordance with the instruction.

According to an example of the present invention, in the storage network system, the pair status of the volume pair is a DUPLEX status, the copy type of the volume pair is a synchronous type, and the copy mode change expectation information is an average response time value.

According to an example of the present invention, in the storage network system, the pair status of the volume pair is the DUPLEX status, the copy type of the volume pair is an asynchronous type, and the copy mode change expectation information is a side file utilization ratio.

According to an example of the present invention, in the storage network system, the pair status of the volume pair is a PENDING status, and the copy mode change expectation information is a time from the start of copying to the end thereof.

According to an example of the present invention, in the storage network system, if there are not enough physical paths to be exclusively allocated to all the groups, allocation is performed by giving higher priority to a group whose copy type is the synchronous type than to a group whose copy type is the asynchronous type and giving higher priority to a group whose pair status is the DUPLEX status than to a group whose pair status is the PENDING status.

According to an example of the present invention, a host computer that is connected to a plurality of storage subsystems via a network and is capable of copying data stored in a logical volume in a storage subsystem into a logical volume in another storage subsystem comprises: an interface connected to the network; and a control section connected to the interface, in which the control section checks a pair status of a volume pair, which is a pair of a source logical volume and a target logical volume that is established between a source storage subsystem and a target storage subsystem, determines a coefficient value uniquely determined from the pair status as a load value of the volume pair, determines, for each group consisting one or more volume pairs, a sum of the load values of the volume pairs in the group as a group load value, and transmits to the storage subsystems via the network an instruction to allocate a number of physical paths corresponding to the group load value and a plural-group load value, which is a sum of the load values of a plurality of groups, to the volume pairs belonging to the group as a logical path, which is a virtual communication link.

According to an example of the present invention, in storage network system comprising a host computer and a plurality of storage subsystems connected to the host computer via a network, the storage network system being capable of copying data stored in a logical volume in a storage subsystem into a logical volume in another storage subsystem, a storage subsystem checks a pair status of a volume pair, which is a pair of a source logical volume and a target logical volume that is established between a source storage subsystem and a target storage subsystem, determines a coefficient value uniquely determined from the pair status as a load value of the volume pair, determines, for each group consisting one or more volume pairs, a sum of the load values of the volume pairs in the group as a group load value, and allocates a number of physical paths corresponding to the group load value and a plural-group load value, which is a sum of the load values of a plurality of groups, to the volume pairs belonging to the group as a logical path, which is a virtual communication link.

According to an example of the present invention, in a storage network system having a host computer and a plurality of storage subsystems connected to the host computer via a network, the storage network system being capable of copying data stored in a logical volume in a storage subsystem into a logical volume in another storage subsystem, a method of allocating a physical path as a logical path comprises: a step of checking a pair status of a volume pair, which is a pair of a source logical volume and a target logical volume that is established between a source storage subsystem and a target storage subsystem; and a step of, on the assumption that a coefficient value uniquely determined from the pair status is a load value of the volume pair and, for each group consisting one or more volume pairs, a sum of the load values of the volume pairs in the group is a group load value, allocating a number of physical paths corresponding to the group load value and a plural-group load value, which is a sum of the load values of a plurality of groups, to the volume pairs belonging to the group as a logical path, which is a virtual communication link.

According to an example of the present invention, in the method of allocating a physical path, the number of volume pairs belonging to a group is 1. That is, in a storage network system comprising a host computer and a plurality of storage subsystems connected to the host computer via a network, the storage network system being capable of copying data stored in a logical volume in a storage subsystem into a logical volume in another storage subsystem, the method of allocating a physical path comprises: a step of checking a pair status of a volume pair, which is a pair of a source logical volume and a target logical volume that is established between a source storage subsystem and a target storage subsystem; a step of, on the assumption that a coefficient value uniquely determined from the pair status is a load value of the volume pair, determining a plural-volume-pair load value, which is a sum of the load values of a plurality of volume pairs; and a step of allocating a number of physical paths corresponding to the determined plural-volume-pair load value and the load value of the volume pair to the volume pair as a logical path, which is a virtual communication link.

According to an example of the present invention, the method of allocating a physical path further comprises: a step of copying data stored in a primary volume, which is a source logical volume, in a first storage subsystem into a secondary volume, which is a target logical volume, in a second storage subsystem or copying data stored in a primary volume in the second storage subsystem into a secondary volume in the first storage subsystem, and checking a pair status of a volume pair, which is a pair of a source logical volume and a target logical volume that is established between the first storage subsystem and the second storage subsystem and which volume of the paired volumes is the source logical volume, in which the group load value used in the allocation step is a direction-based load value, which is a sum of the load values of volume pairs, whose source logical volumes reside in the first storage subsystem, of plural groups of volume pairs established between the first storage subsystem and the second storage subsystem. That is, in the storage network system comprising a host computer and a plurality of storage subsystems connected to the host computer via a network, the storage network system being capable of copying data stored in a primary volume, which is a source logical volume, in a first storage subsystem into a secondary volume, which is a target logical volume, in a second storage subsystem or copying data stored in a primary volume in the second storage subsystem into a secondary volume in the first storage subsystem, the method of allocating a physical path as a logical path comprises: a step of checking a pair status of a volume pair, which is a pair of a source logical volume and a target logical volume that is established between the first storage subsystem and the second storage subsystem and which of the paired volumes is the source logical volume; a step of determining a coefficient value uniquely determined from the pair status as a load value of the volume pair, determining, for each of groups consisting of one or more volume pairs, a sum of the load values of the volume pairs belonging to the group as a group load value, and determining a plural-group load value, which is a sum of the group load values of the groups; determining a direction-based load value, which is a sum of the load values of a plurality of volume pairs, whose source logical volumes reside in the first storage subsystem, of the plural groups of volume pairs; and a step of allocating a number of physical paths corresponding to the determined direction-based load value and the plural-group load value to the volume pairs whose source logical volumes reside in the first storage subsystem as a logical path, which is a virtual communication link.

According to an example of the present invention, in the method of allocating a physical path, physical paths are allocated to volume pairs as a logical path, which is a virtual communication link, in ascending order of the load values of the physical paths. That is, in the storage network system comprising a host computer and a plurality of storage subsystems connected to the host computer via a network, the storage network system being capable of copying data stored in a logical volume in a storage subsystem into a logical volume in another storage subsystem, the method of allocating a physical path comprises: a step of checking a pair status of a volume pair, which is a pair of a source logical volume and a target logical volume that is established between a source storage subsystem and a target storage subsystem; a step of determining a coefficient value uniquely determined from the pair status as a load value of the volume pair, determining, for each of groups consisting of one or more volume pairs, a sum of the load values of the volume pairs belonging to the group as a group load value, and determining a plural-group load value, which is a sum of the group load values of the groups; and a step of allocating physical paths to volume pairs as a logical path, which is a virtual communication link, in ascending order of the load values of the physical paths.

According to an example of the present invention, in the method of allocating a physical path, the load value is determined on the assumption that the coefficient value at the time when the pair status is a PENDING status is 1, the coefficient value at the time when the pair status is a DUPLEX status is an update frequency coefficient, which is a ratio of the amount of data transferred when the pair status is the DUPLEX status to the amount of data transferred when the pair status is the PENDING status, and the coefficient value at the time when the pair status is neither the PENDING status nor the DUPLEX status is 0.

According to an example of the present invention, in the storage network system comprising a host computer and a plurality of storage subsystems connected to the host computer via a network, the storage network system being capable of copying data stored in a logical volume in a storage subsystem into a logical volume in another storage subsystem, the method of allocating a physical path as a logical path further comprises: a step of checking a copy type and a pair status of and copy mode change expectation information about a volume pair belonging to a group to which a source logical volume belongs; and a step of exclusively allocating a physical path for the volume pair to a logical path, which is a virtual communication link, for the volume pair belonging to the group if the copy mode change expectation information exceeds an allowable value previously individually specified for the group.

According to an example of the present invention, in the method of allocating a physical path, the pair status of the volume pair is a DUPLEX status, the copy type of the volume pair is asynchronous type, and the copy mode change expectation information is an average response time value.

According to an example of the present invention, in the method of allocating a physical path, the pair status of the volume pair is the DUPLEX status, the copy type of the volume pair is an asynchronous type, and the copy mode change expectation information is a side file utilization ratio.

According to an example of the present invention, in the method of allocating a physical path, the pair status of the volume pair is a PENDING status, and the copy mode change expectation information is a time from the start of copying to the end thereof.

According to an example of the present invention, in the method of allocating a physical path, if there are not enough physical paths to be exclusively allocated to all the groups, allocation is performed by giving higher priority to a group whose copy type is the synchronous type than to a group whose copy type is the asynchronous type and giving higher priority to a group whose pair status is the DUPLEX status than to a group whose pair status is the PENDING status.

According to the examples described above, even if there are not enough physical paths to be exclusively occupied, the frequency of stops of differential data transfer due to timeout can be reduced because higher priority is given to a group whose copy type is the synchronous type, for which a timeout is more likely to occur, than to a group whose copy type is the asynchronous type, and higher priority is given to a group whose pair status is the DUPLEX status, for which a stop of the differential data transfer has a greater effect, than to a group whose pair status is the PENDING status.

In addition, since the number of physical paths exclusively allocated to the transfer directions is determined according to the load values calculated on a volume basis, on a group basis or a transfer-direction basis depending on the pair status or update frequency of a volume pair, and the physical paths to be shared are allocated to logical paths so that the logical paths have an equal load value, the loads on the shared physical paths and the loads on the exclusively occupied physical paths can be made equal to each other, the loads for the transfer directions can be made equal to each other, and the loads on the shared physical paths can be made equal to each other.

What is claimed is:

1. A storage network system, comprising:
a host computer; and
a plurality of storage subsystems connected to the host computer via a network, the storage network system being capable of copying data stored in a logical volume in a storage subsystem into a logical volume in another storage subsystem,
wherein said host computer checks a pair status of a volume pair, which is a pair of a source logical volume and a target logical volume that is established between a source storage subsystem and a target storage subsystem, determines a coefficient value uniquely determined from said pair status as a load value of the volume pair, determines, for each group consisting one or more volume pairs, a sum of the load values of the volume pairs in the group as a group load value, and transmits to said storage subsystems via the network an instruction to allocate a number of physical paths corresponding to said group load value and a plural-group load value, which is a sum of the load values of a plurality of groups, to the volume pairs belonging to said group as a logical path, which is a virtual communication link, and said storage subsystems perform allocation of a logical path in accordance with said instruction.

2. The storage network system according to claim 1, wherein the number of volume pairs belonging to said group is 1.

3. The storage network system according to claim 1, wherein said host computer is capable of copying data stored in a primary volume, which is a source logical volume, in a first storage subsystem into a secondary volume, which is a target logical volume, in a second storage subsystem or copying data stored in a primary volume in the second storage subsystem into a secondary volume in the first storage subsystem, checks a pair status of a volume pair, which is a pair of a source logical volume and a target logical volume that is established between said first storage subsystem and said second storage subsystem, and checks which volume of the paired volumes is the source logical volume, and the group load value used in allocation is a direction-based load value, which is a sum of the load values of volume pairs, whose source logical volumes reside in said first storage subsystem, of plural groups of volume pairs established between the first storage subsystem and the second storage subsystem.

4. The storage network system according to claim 1, wherein said host computer allocates physical paths to volume pairs as a logical path, which is a virtual communication link, in ascending order of the load values of the physical paths.

5. The storage network system according to any one of claims 1 to 4, wherein said host computer determines the load value on the assumption that said coefficient value at the time when said pair status is a PENDING status is 1, said coefficient value at the time when said pair status is a DUPLEX status is an update frequency coefficient, which is a ratio of the amount of data transferred when the pair status is the DUPLEX status to the amount of data transferred when the pair status is the PENDING status, and said coefficient value at the time when said pair status is neither the PENDING status nor the DUPLEX status is 0.

6. A storage network system, comprising:
a host computer; and
a plurality of storage subsystems connected to the host computer via a network, the storage network system being capable of copying data stored in a logical volume in a storage subsystem into a logical volume in another storage subsystem,
wherein said host computer checks a copy type and a pair status of and copy mode change expectation information about a volume pair belonging to a group to which a source logical volume belongs, and transmits to said network subsystems via the network an instruction to exclusively allocate a physical path for said volume pair to a logical path, which is a virtual communication link, for the volume pair belonging to said group if said copy mode change expectation information exceeds an allowable value previously individually specified for the group, and said storage subsystems perform allocation of a logical path in accordance with said instruction.

7. The storage network system according to claim 6, wherein said pair status of said volume pair is a DUPLEX status, said copy type of said volume pair is a synchronous type, and said copy mode change expectation information is an average response time value.

8. The storage network system according to claim 6, wherein said pair status of said volume pair is the DUPLEX status, said copy type of said volume pair is an asynchronous type, and said copy mode change expectation information is a side file utilization ratio.

9. The storage network system according to claim 6, wherein said pair status of said volume pair is a PENDING status, and said copy mode change expectation information is a time from the start of copying to the end thereof.

10. The storage network system according to claim 6, wherein, if there are not enough physical paths to be exclusively allocated to the groups, said host computer transmits to said storage subsystems via the network an instruction to perform allocation by giving higher priority to a group whose copy type is the synchronous type than to a group whose copy type is the asynchronous type and giving higher priority to a group whose pair status is the DUPLEX status than to a group whose pair status is the PENDING status, and said storage subsystems perform allocation of a logical path in accordance with said instruction.

11. A host computer that is connected to a plurality of storage subsystems via a network and is capable of copying data stored in a logical volume in a storage subsystem into a logical volume in another storage subsystem, comprising:
an interface connected to the network; and
a control section connected to said interface,
wherein said control section checks a pair status of a volume pair, which is a pair of a source logical volume and a target logical volume that is established between a source storage subsystem and a target storage subsystem, determines a coefficient value uniquely determined from said pair status as a load value of the volume pair, determines, for each group consisting one or more volume pairs, a sum of the load values of the volume pairs in the group as a group load value, and transmits to said storage subsystems via the network an instruction to allocate a number of physical paths corresponding to said group load value and a plural-group load value, which is a sum of the load values of a plurality of groups, to the volume pairs belonging to said group as a logical path, which is a virtual communication link.

12. In a storage network system having a host computer and a plurality of storage subsystems connected to the host computer via a network, the storage network system being capable of copying data stored in a logical volume in a storage subsystem into a logical volume in another storage subsystem, a method of allocating a physical path as a logical path, comprising:
a step of checking a pair status of a volume pair, which is a pair of a source logical volume and a target logical volume that is established between a source storage subsystem and a target storage subsystem; and
a step of, on the assumption that a coefficient value uniquely determined from said pair status is a load value of the volume pair and, for each group consisting one or more volume pairs, a sum of the load values of the volume pairs in the group is a group load value, allocating a number of physical paths corresponding to said group load value and a plural-group load value, which is a sum of the load values of a plurality of groups, to the volume pairs belonging to said group as a logical path, which is a virtual communication link.

13. The method of allocating a physical path according to claim 12, wherein the number of volume pairs belonging to said group is 1.

14. The method of allocating a physical path according to claim 12, further comprising:
a step of copying data stored in a primary volume, which is a source logical volume, in a first storage subsystem into a secondary volume, which is a target logical volume, in a second storage subsystem or copying data stored in a primary volume in the second storage subsystem into a secondary volume in the first storage subsystem, and checking a pair status of a volume pair, which is a pair of a source logical volume and a target logical volume that is established between said first storage subsystem and said second storage subsystem and which volume of the paired volumes is the source logical volume,
wherein the group load value used in allocation is a direction-based load value, which is a sum of the load values of volume pairs, whose source logical volumes reside in said first storage subsystem, of plural groups of volume pairs established between the first storage subsystem and the second storage subsystem.

15. The method of allocating a physical path according to claim 12, wherein in said allocating step, physical paths are allocated to volume pairs as a logical path, which is a virtual communication link, in ascending order of the load values of the physical paths.

16. The method of allocating a physical path according to anyone of claims 12 to 15, wherein the load value is determined on the assumption that said coefficient value at the time when said pair status is a PENDING status is 1, said coefficient value at the time when said pair status is a DUPLEX status is an update frequency coefficient, which is a ratio of the amount of data transferred when the pair status is the DUPLEX status to the amount of data transferred when the pair status is the PENDING status, and said coefficient value at the time when said pair status is neither the PENDING status nor the DUPLEX status is 0.

17. The method of allocating a physical path according to claim 12, further comprising:
a step of checking a copy type and a pair status of and copy mode change expectation information about a volume pair belonging to the group to which said source logical volume belongs; and
a step of exclusively allocating a physical path for said volume pair to a logical path, which is a virtual communication link, for the volume pair belonging to said group if said copy mode change expectation information exceeds an allowable value previously individually specified for the group.

18. The method of allocating a physical path according to claim 12, wherein, if there are not enough physical paths to be exclusively allocated to the groups, allocation is performed by giving higher priority to a group whose copy type is the synchronous type than to a group whose copy type is the asynchronous type and giving higher priority to a group whose pair status is the DUPLEX status than to a group whose pair status is the PENDING status.
